(19) United States
(12) Patent Application Publication
(10) Pub. No.: US 2017/0019471 A1
(43) Pub. Date: Jan. 19, 2017

(54) SYSTEM AND METHOD FOR SOCIAL MUSIC COMPOSITION

(71) Applicant: Paisley Richard Nickelson, II, Hartsville, SC (US)

(72) Inventor: Paisley Richard Nickelson, II, Hartsville, SC (US)

(21) Appl. No.: 14/797,821

(22) Filed: Jul. 13, 2015

(51) Int. Cl. H04L 29/08; G06Q 50/00; G06Q 20/12; G06Q 30/02; H04L 29/06; G06Q 20/10

(52) U.S. Cl. CPC H04L 67/1095; H04L 67/12; H04L 67/42; G06Q 20/10; G06Q 20/1235; G06Q 30/0277; G06Q 50/01

(57) ABSTRACT

The present invention relates to a social media site that allows for music composition, safety and sharing in a protected way.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

Field of the Invention

The present invention relates to music composition. In particular, it relates to a social media system and method designed to afford large numbers of people to participate or share in the music composition process.

Description of Related Art

The production of music is as old as recorded history. Most music is still composed, arranged, edited, and the like by individuals on their instruments. Recording and editing functions have now gone mostly digital and can be easily done digitally. Musical arrangement and composition, including production, has gotten difficult because of the ease of which digital music can be pirated and otherwise shared. Management of the whole process is now very difficult and, in many cases, can lead to a total loss of income and control of music production. Nothing is available to control the music production and management process in a manner to allow the individual to still make money and produce music.

### BRIEF SUMMARY OF THE INVENTION

The present invention overcomes problems of the prior art by providing a system online for the management of music composition and distribution. By doing management on a social media site, rather than on computer software or cloud software, the user can interact with others and charge others in a controlled way, rather than just putting music out on the internet for anyone to see, steal or the like.

Accordingly, the invention relates to an internet social network and communication system for a plurality of clients comprising:
a) a core system module having a server connected to the internet for storing and maintaining information received from a client;
b) an external module wherein a client can access the core system module via the external module;
c) wherein the core system comprises an interactive system for the management of each client's music composition; and
d) wherein the core system comprises a communication system for securely exchanging music composition between clients.

### BRIEF DESCRIPTION OF THE DRAWINGS

FIG. 1 is a relationship figure of the parts of the system of the present invention.

FIG. 2 is a flow chart of the use of the system of the present invention.

### DETAILED DESCRIPTION OF THE INVENTION

While this invention is susceptible to embodiment in many different forms, there is shown in the drawings and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

References throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts is in some way inherently mutually exclusive.

The drawings featured in the figures are for the purpose of illustrating certain convenient embodiments of the present invention, and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

According to some embodiments, a “user device” may comprise one or more types of computing devices that may be used by an end user. Some types of users may find it beneficial to use a mobile device controlled (e.g., by a processor executing computer software application instructions) in accordance with one or more of the embodiments described in this disclosure. In one example, a user device may comprise a smartphone or other personal mobile device. Other types of computing devices that may be used as user devices are discussed in this disclosure, and still others suitable for various embodiments will be apparent to those of ordinary skill in light of this disclosure.

As used in this disclosure, a “computing device” such as a “mobile device” and “portable device” may refer to, without limitation, mobile telephones, cellular telephones, laptop computers, GPS navigation devices, smartphones, such as a Blackberry, Palm, Windows 7, iPhone, Galaxy Nexus, or Droid phone, tablet computers such as an iPad by Apple, Slate by HP, Ideapad by Lenovo, Xoom by Motorola, Kindle Fire HD by Amazon, Note II by Samsung, or Nexus 7 by Google, a handheld computer, a wearable computer, a personal digital assistant, a cellular telephone, a network appliance, a camera, a smartphone, a network base station, a media player, a navigation device, a game console, a tablet computer, or any combination of any two or more of such computing devices.

It should be understood that the embodiments described in this disclosure are not limited to use with mobile devices (although some preferred embodiments are described with reference to such devices, for ease of understanding), but are equally applicable to any network device, user device, or other computing device, such as a personal desktop computer with a browser application and Internet access (e.g., in a user's home or office). Any embodiments described with reference to a mobile device in this disclosure should be understood to be equally applicable to any such other types of computing device, as deemed appropriate for any particular implementation(s).

As used herein, the phrases “computer-implemented social network” and “social network and communication system” may be used interchangeably and refer to a system for social interaction between a plurality of “clients” or participants (e.g., individuals or organizations). A social network provides tools for communication between its participants, defines complex links or connections between them, and provides ways for internal organization of these participants. Participants can connect to a social network via various web-based and mobile technologies and devices. Some examples of computer-implemented social networks include Facebook®, Snapfish®, Twitter®, LinkedIn®, and other similar social networks. In one embodiment, the network can handle/translate multiple languages e.g. using translation software.

Some of these social networks can be very large (e.g., with hundreds of thousands, or even millions, of participants). These participants are linked (i.e., connected) to other participants of the social network. Where some participants may be connected to a very large number of other participants (e.g., thousands), in many situations, the participants of these computer-implemented social networks actively communicate with each other (e.g., by sending messages, sharing files, links, or other information, co-managing music production, etc.). A company may be also defined as a “social network” when social networking exists between the company's internal users (e.g., Snapfish® customers sharing pictures) but the company is not in the business of running a social network platform. These and other types of social interactions define the “social profile” of the network participants and generate social information related to the participants. Further, the participants can take advantage of various tools or programs offered by the social networks and can make purchases of products or services that are offered by the social networks or any of their partners (e.g., advertisers, especially those service providers offering services of interest to the music business). In addition, some participants can influence other participants to make purchases by sharing links or other information directed to products and services. These types of business transactions and interactions define the “business profile” of the network participants and generate business value information related to the participants.

Analyzing the participants of the social networks and their activities is a high priority for the companies that operate these networks. A precise analysis of the participants, their connections, activities, behavior, influence, purchasing habits, etc. allows the companies to improve the quality of the services or products offered by the networks, to market the products they offer more successfully, and to increase the number of participants. Specifically, the companies want to “slice and dice” (i.e., analyze) their participants from different perspectives in order to understand what is their direct and indirect business value (e.g., in terms of direct profit from purchases and profit generated from sharing information to other participants) in the short-term and in the long-term. Further, the companies want to identify their key or important participants and be able to receive insights that will help them to communicate better and address issues more efficiently. With the marketing landscape's changing standards for connected participants that share information and products, it is necessary for the companies operating the social networks to jointly evaluate the social profile of the participants, as well as their business profile.

This description is directed to systems, methods, and machine-readable storage media to analyze a plurality of participants in a computer-implemented social network. Further, the proposed systems, methods, and machine-readable storage media generate a dynamic interactive graphical representation for analyzing the plurality of participants in a computer-implemented social network. In one example, by using the techniques described below, different social information and business information related to the participants in a social network can be obtained, processed, and graphically represented. Every social network collects different information for its participants. The main body of collected information can be systematically analyzed, reduced, or organized into smaller parts or views to examine it from different viewpoints. The systematically organized and analyzed information can be then presented in a variety of different and useful visual ways. In one embodiment, information, music, and videos are delivered by streaming, as common in the art.

As used herein, the terms “Internet” and “internet” are used interchangeably to refer to inter-networks including, without limitation, the Internet.

As used herein, the term “memory” includes any type of integrated circuit or other storage device adapted for storing digital data including, without limitation, ROM, PROM, EEPROM, DRAM, SDRAM, DDR/2 SDRAM, EDOIFPMS, RLDRAM, SRAM, “flash” memory (e.g., NAND/NOR), and PSRAM.

As used herein, the term “server” refers to any computerized component, system or entity, regardless of form, which is adapted to provide data, files, applications, content, or other services to one or more other devices or entities on a computer network.

As used herein, the phrase “user interface” refers to, without limitation, any visual, graphical, tactile, audible, sensory, or other means of providing information to and/or receiving information from a user or other entity.

As used herein, the term “WiFi” refers to, without limitation, any of the variants of IEEE-Std. 802.11 or related standards including 802.11 a/b/g/i/n.

As used herein, the term “wireless” means any wireless signal, data, communication, or other interface including without limitation WiFi Bluetooth, 3G, HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, analog cellular, CDPD, satellite systems, millimeter wave or microwave systems, acoustic, and infrared (i.e., IrDA).

As used herein the phrase “core system module” refers to programs, or other active parts of a company, running a social network of the present system, which includes submodules to run the social network service, wherein the programs and other digital information is contained on a server. It includes the ability to access the internet so that clients can access the social media site which is available on the internet. One module is an interactive system for the management of each client's music composition. Another is a communication system for securely exchanging music compositions between clients, as well as other aspects of communication as noted above.

As used herein the phrase “management of each client's music composition” refers to a computer software program(s) which allow the users to compose, arrange, record, edit, mix, or master a new music composition using any instrument, including voice. It also includes music video insertion and composition, so that music creations can be inserted where necessary in a video. Currently, there are programs to perform such tasks, but none that allow client interaction in the process of music management, including the composing and the like of a musical composition. Nothing allows the user in a social networking setting to allow the exchange of partial or completed music compositions or the like, especially in a secure method such that only clients on the social media site can have access to the music without further intermediary interference or use. This particular method also allows control of the media, and, to a great extent, prevents theft of the music composition by limiting access to just the client. Access to the social media site can be by fee and require a security process before allowing a client to sign up, thus reducing theft possibilities. In one embodiment, a client would pay a fee to access the composition of another client or to have access to an uncompleted work, and either listen to or participate in the composition, or the like, process. Accordingly, in one embodiment, the system allows for a transfer of money between clients. Third party (or other external modules) modules can also be used to provide services through the core system module, though not directly part of the core system. In one embodiment, the system provides video recording and editing, including adding music created on the system to a video.

As used herein, the phrase “external module wherein a client can access the core system module” refers to a computing device, or the like, which provides access to the internet, and thus the core system which is linked to the internet.

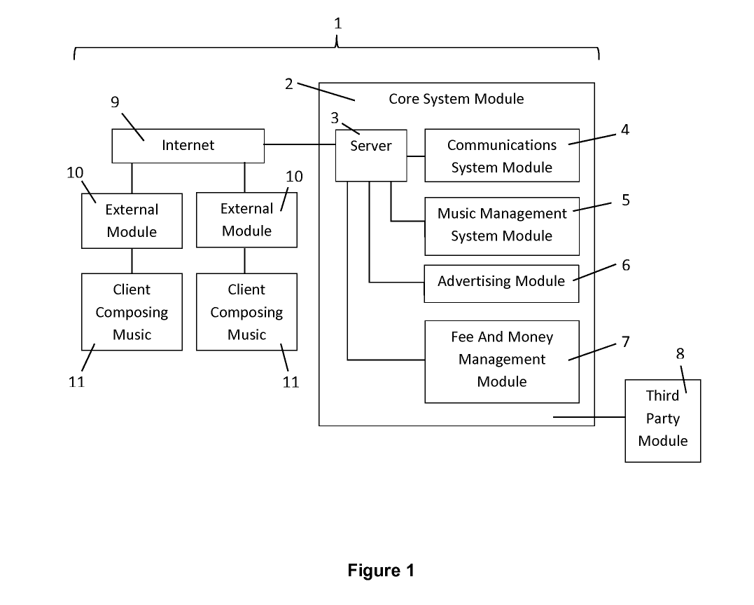

Now referring to the drawings, FIG. 1 refers to a relationship chart of the parts of the system of the present invention. The internet social network and communication system 1 is comprised of several parts. The core system module 2 consists of a server 3, a communication system module 4, a music management system module 5, an advertising module 6, a fee and money management module 7 and at least one third party (external) module 8.

Communication over the internet 9 to the core system module 3 has a social media present on the internet 9. In the shown embodiment, a plurality of client modules 10, each operated by a client 11, access the core's system module through the internet 9 to manage music composition, using the music management system module 5 and communicate with other clients using the communications module 4. Other modules are used as necessary to access advertising, pay and receive fees, and access third party software. The client 11 uses any instrument including voice to compose and manage the music composition process.

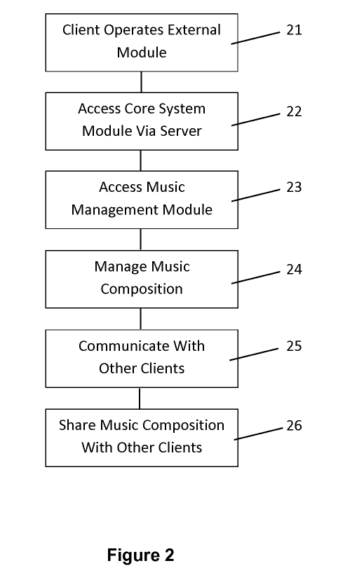

FIG. 2 is a flowchart of use of the internet social network and communication system. A client operates the external module 21 via a computer to access the internet and a web site operating the access core system which operates a server 22. The client then access the music management module 23 for composing music and other music management activities 24 as disclosed herein. While using the social network, the client can communicate with other clients 25 and share music composition with other clients 26 for free or on a fee basis.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. An internet social network and communication system for a plurality of clients comprising:
a) a core system module having a server connected to the internet for storing and maintaining information received from a client;
b) an external module wherein a client can access the core system module via the external module;
c) wherein the core system comprises an interactive system for the management of each client's music composition; and
d) wherein the core system comprises a communication system for securely exchanging music composition between clients.

2. The system according to claim 1 wherein the core system music management allows the user to perform at least one of music composition, arrangement, recording, editing, mixing and mastering.

3. The system according to claim 1 wherein the music composition is at least one of voice or musical instrument.

4. The system according to claim 1 wherein multiple clients can compose on the same music composition via the core system module.

5. The system according to claim 1 wherein the external module is a computing device.

6. The system according to claim 5 wherein the computing device is at least one of a smart phone, a computer, a laptop and a tablet.

7. The system according to claim 1 wherein the music composition includes video composition.

8. The system according to claim 1 wherein access to a music composition by other than a composer is by payment of a fee.

9. The system according to claim 1 wherein the system allows music composition management service providers to advertise on the system to the plurality of clients.

10. The system according to claim 1 wherein the system allows transfer of money between clients.

11. The system according to claim 1 wherein the information is sorted on computer readable media.

12. The system according to claim 1 wherein the external module has WiFi capabilities.
